(19) United States
(12) Patent Application Publication
(10) Pub. No.: US 2017/0193807 A1
(43) Pub. Date: Jul. 6, 2017

(54) ALARM SYSTEM ON A DEVICE CONNECTED TO A NETWORK

(71) Applicant: Baha Samara, McKinney, TX (US)

(72) Inventor: Baha Samara, McKinney, TX (US)

(21) Appl. No.: 15/394,802

(22) Filed: Dec. 29, 2016

Related U.S. Application Data
(60) Provisional application No. 62/274,121, filed on Dec. 31, 2015.

(51) Int. Cl. G08B 25/01; H04W 4/02; G08B 25/10

(52) U.S. Cl. CPC G08B 25/016; G08B 25/10; H04W 4/023

(57) ABSTRACT

An alarm system includes an alarm device connected to a network. The alarm device is used to activate a reverse timer during a potential emergency situation. The user is prompted to enter a code at the end of the time period for the reverse timer. If the proper code is entered, then the timer is restarted and information about the alarm device is sent over the network. If the proper code is not entered, then an emergency situation is determined and the proper authorities alerted.

### FIELD OF THE INVENTION

The invention relates to providing an alarm system on a device connected to a network. The alarm system interacts with a user to determine an emergency situation and relays this information.

### DISCUSSION OF THE RELATED ART

A typical alarm system will trigger and initiate emergency preparedness procedures when an event occurs. A door is opened, motion is detected and the like to send a signal to a monitoring service or the police/fire services that something is happening. The monitoring service then tries to contact the user to determine whether a real emergency has occurred or if it just a false alarm. For example, someone trips an alarm accidentally and the monitoring service calls for a password to call off sending the authorities. These actions are time consuming and only act when something occurs.

Other processes involve calling 9-1-1 or pressing a button on a device to alert the police. Even then, the user has to provide location information or talk to a dispatcher to describe the situation. This action involves the user having to reveal their location and spend precious time describing what is going on. Further, the user may be unable to speak or provide such information. Pressing a button can be done inadvertently and result in false alarms.

In addition to the problems described above, current systems are not efficient as they require a user to assess a situation to make a judgment call. If the user's judgment is incorrect, then resources are wasted responding to a non-emergency, or, alternatively, the user is harmed after believing the situation does not warrant any action.

Other systems may pertain to running or jogging applications. One includes allowing others to track a person as they run and then send an alert with a location with the person stops jogging for a period of time. The application also may provide alerts to the jogger every minute. The jogger, however, may not want their location known to everyone or provide information on their routes that can be tracked online. Further, if one does not keep moving, then the alarms and alerts will go off. This may be inconvenient or embarrassing.

Other applications allow a person to turn their phone or device into a siren that makes audible alarms and sends a GPS location to contacts. Again, these systems may result in false alarms and needless waste of resources if the user keeps sending alarms. Some of these applications also provide the ability of others to track one at all times. As noted above, not everyone wants to provide their location information and preferred routes to everyone.

Other applications may request that the user check-in after a period of time during a walk or jog. If one does not respond to the check-in, then an alert may be sent to contacts. Problems with this application include use only during exercising. Not every alert situation involves exercising. Further, these applications merely require the use of “ok” or other simple responses to delay or turn off the alarm. An attacker can respond for the victim or force the victim to respond to make sure no alerts are sent.

### SUMMARY OF THE INVENTION

The disclosed embodiments include applications and associated methods to provide an alarm system on a device connected to a network. The alarm system includes features that differ from known alarm systems and are tailored to emphasize the safety of the user while not wasting resources and time of first responders with false alarms. It also tracks usage and other analytics that may be used to prevent further emergency situations or identify problem areas.

Preferably, the user runs an application on a device. The device is connected to a network to exchange information over the network. The application executes on the device to turn the device into a special purpose machine, namely an alarm and tracking device. The user initiates the application to configure the device to the alarm and tracking device.

The configured device implements a reverse alarm capability. In other words, the user engages the alarm application when a possible emergency situation is detected. The alarm device then counts down with a timer. The user enters a code to keep extending the alarm timer. If the user fails to enter the code, then the appropriate authorities or personnel are contacted over the network. Further, the user, at any time, may enter an emergency code to imply that she is in immediate danger. Other codes also may be entered to perform specific functions.

The configured alarm device and system provide range extension and location freedom. Unlike house or car alarm systems, the user may bring the disclosed alarm system wherever she goes. The disclosed alarm device and system may be used outside the range of a current system. The user may engage the alarm device and system anyplace with a network connection outside the home, specific location or even in a different city or state. The disclosed embodiments also may operate in conjunction with current systems.

The disclosed embodiments also may collect data, or a “hazard score,” for an area based on the shared alarm information received over the network. As users execute the application to configure their devices into alarm devices, the number of occurrences indicates the possibility of an emergency for those locations. Further, if a user initiates the alarm application on a frequent basis, then she may be alerted for possible actions to take to decrease the possibility of an emergency situation. This information may be used for targeted offers or suggestions to the user.

According to the disclosed embodiments, existing devices may be configured to execute the functions described herein. The user does not need to purchase special equipment. Alternatively, in some situations, a dedicated device may be used to execute the functions disclosed below. A configured alarm device may be a specialized wearable alarm device for the user to initiate while out. Preferably, the alarm device is a smart device, such as a smart phone, smart watch, personal digital assistant, and the like, that executes a variety of applications. The user opens the disclosed application to begin the reverse alarm process.

Unlike existing applications, the disclosed embodiments allow for a user to activate the alarm at their discretion. Further, the user does not have to be jogging or exercising to use the disclosed process. The user can activate it anytime for any reason. The disclosed embodiments also allow for the user to enter a code that performs one of a variety of functions. Thus, an attacker may think that an alert has been delayed when, in fact, the code alerts others to the situation. Moreover, the existing applications may not provide the analytics for an area to determine dangerous zones or false alarms locations.

### BRIEF DESCRIPTION OF THE DRAWINGS

The accompanying drawings are included to provide further understanding of the invention and constitute a part of the specification. The drawings listed below illustrate embodiments of the invention and, together with the description, serve to explain the principles of the invention, as disclosed by the claims and their equivalents.

FIG. 1 illustrates an alarm system according to the disclosed embodiments.

FIG. 2 illustrates a flowchart for installing and starting the disclosed application for configuring a device into an alarm device according to the disclosed embodiments.

FIG. 3 illustrates a flowchart for performing alarm operations using the device within the alarm system according to the disclosed embodiments.

FIG. 4 illustrates a flowchart for performing a hazard score based alarm process according to the disclosed embodiments.

FIG. 5 illustrates a screenshot on a display device that embodies the invention according to the disclosed embodiments.

FIG. 6 illustrates an emergency alarm displayed on a device that embodies the invention according to the disclosed embodiments.

FIG. 7 illustrates a family and/or friend alarm displayed on a device that embodies the invention according to the disclosed embodiments.

FIG. 8 illustrates an active alarm displayed on a device that embodies the invention according to the disclosed embodiments.

FIG. 9 illustrates an advertisement displayed on a device that embodies the invention according to the disclosed embodiments.

FIG. 10 illustrates an events list displayed on a device that embodies the invention according to the disclosed embodiments.

FIG. 11 illustrates an event map displayed on a device that embodies the invention according to the disclosed embodiments.

FIG. 12 illustrates a path taken by a user on a map which is displayed on a device that embodies the invention according to the disclosed embodiments.

### DETAILED DESCRIPTION OF THE PREFERRED EMBODIMENTS

Aspects of the invention are disclosed in the accompanying description. Alternate embodiments of the present invention and their equivalents are devised without parting from the spirit or scope of the present invention. It should be noted that like elements disclosed below are indicated by like reference numbers in the drawings.

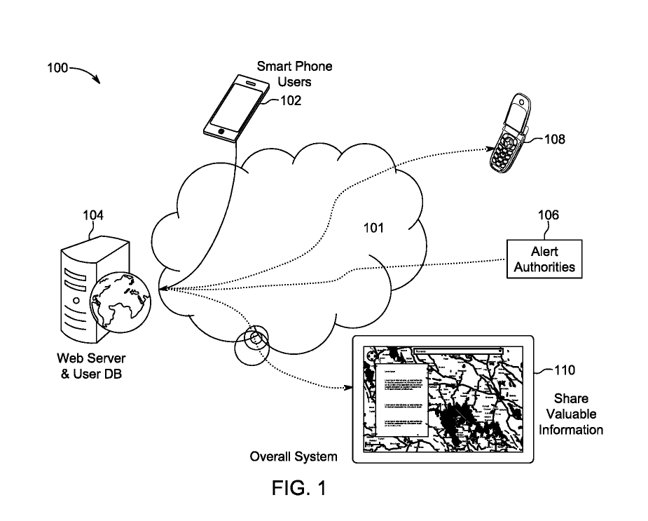

FIG. 1 depicts an alarm system 100 according to the disclosed embodiments. Alarm system 100 includes various entities to support the reporting of emergency situations and track users as they initiate the application to configure their devices into alarm devices.

Referring to FIG. 1, system 100 includes various components that exchange data over a network 101. Network 101 may be the Internet, a local area network, wide area network, wired or wireless network, and the like. Preferably, network 101 is a cellular network that exchanges data from devices to other devices. Network 101 may be supported by a protocol and platform that allows for the data to be exchanged. Network 101 also may be a combination of networks.

Device 102 is connected to network 101. Device 102, as disclosed above, may be a smart device or phone capable of executing applications. Device 102 preferably includes a processor coupled to a memory that stores the application. The processor executes the steps needed to run the application. Device 102 also may include input/output ports, a display, interfaces and other components known in the art to input information and interact with the application. Further, a plurality of devices 102 may be connected to network 101. Device 102 also may be a device executing a software program to enable the device to perform the functions disclosed below. Device 102 is used by a user.

An application, or “app,” refers to any mobile application, web application, tablet application, stand-alone application, web service application and the like. The disclosed application uses an application program interface to input commands and instructions as disclosed below. The application, when launched, configures device 102 into an alarm device 102. Though some background functionality is still provided (such as a clock), device 102 only executes alarm device functions when the device is configured as an alarm device. Alarm system 100 interacts with device 102 when it is configured as an alarm device.

Alarm system 100 also includes web server 104. Web server 104 may include a user database of information collected from device 102. The functionality of web server 104 is disclosed in greater detail below. Web server 104 may host the accounts for devices 102 (and associated users) connected via network(s) 101. The accounts may include contact information and other data needed to address an emergency situation for the user in the user database. Web server 104 also may include analytics and data mining capabilities to support some of the expanded functionality of alarm system 100.

Authorities 106 may refer to the police, fire, hospital, emergency, and the like, services for alerting that the user of device 102 is in an emergency situation. Authorities 106 may be known as first responders, as in they are the first people to respond to an emergency. Authorities 106 also may be school officials, office security personnel or a command group that needs to know when the user of device 102 is in the emergency situation.

Authorities 106 may generally refer to these groups, but really refers to devices, computers or other data reception devices that provide information to the first responders. This information may be sent as a text message, phone call, email, instant message or any data exchange process. In some embodiments, a service at a central location, such as one hosting web server 104, may alert authorities 106.

Device 108 may refer to a device used by a family member or friend of the user. Once an emergency situation is detected, data is sent to device 108 to alert the family member or friend. Device 108 does not necessarily need to execute the application of the disclosed embodiments to receive this data. Device 108 also may refer to a plurality of devices used to family members and friends. In fact, more than one device 108 is preferred to receive information when the user of device 102 is in an emergency.

Interface device 110 may refer to another device used within alarm system 100 to share valuable information and analytics collected via network 101. Interface device 110 may be used by the user to track various devices and accounts, or to receive overall alarm system 110 feedback. Further, interface device 110 may refer to a device used by operators of alarm system 100 to identify hazard areas as determined by the number of emergency situations reported in the alarm system.

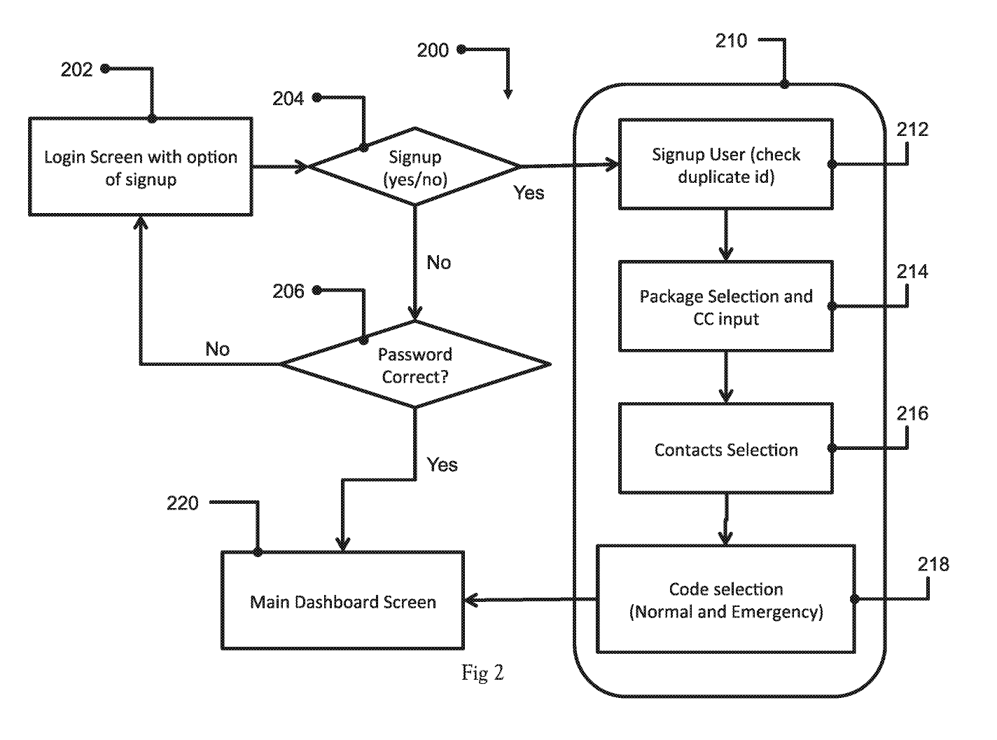

FIG. 2 depicts a flowchart 200 for installing and starting the disclosed application for configuring a device 102 into an alarm device according to the disclosed embodiments. Flowchart 200 may refer back to components of alarm system 100 for illustrative purposes. The functions of flowchart 200 may be downloaded to device 102 or device 110 (or any computing device) to allow the user to open an alarm system account. The application may be downloaded from web server 104 over network 101.

Step 202 executes by displaying a login screen with an option to sign up to engage with alarm system 100. The user is given a prompt when the application is first opened on device 102, for example, to indicate whether she wants to sign up. “Sign up” may refer to opening an account on alarm system 100.

Step 204 executes by determining whether the user responded by indicating yes or no in regards to signing up for an account. If no, then step 206 executes where it is understood that the user already has an account. The user will provide account name and password which will be used to determine whether an entered username and password is correct. Preferably, alarm system 100 recognizes the account corresponding to device 102 and its associated user. If step 206 is no, then flowchart 200 returns to step 202 to request login information. If step 206 is yes, then that indicates to proper credentials have been established and flowchart 200 goes to step 220.

If step 204 is yes, then a new account must be created for the user of the device. Process 210 is executed. Process 210 may include additional steps beyond those shown in FIG. 2. Process 210 also may be executed on device 102, or over network 101 on web server 104.

Step 212 executes by requesting the user provide an account identification (or name) to uniquely identify the user. The disclosed embodiments may check to see if another user is using the entered account identification. If so, then the user may be prompted to select new account identification. Otherwise, step 214 executes by selecting a package for the account and inputting a payment option, such as a credit card. The user may select from a plurality of account types. The price, if any, depends on the services desired.

Step 216 executes by selecting contacts for the account to be alerted in the event of an emergency. The number of contacts may be limited based on the type of account selected in step 214. The user may be asked to input information for each contact using the application or allow user to select from an existing contact list available on the device. Step 218 executes selecting codes for normal operation and emergency situations. Preferably, these codes are personal identification numbers entered on a numeric pad hosted by the application. One code initiates normal alarm processes (“Normal Code”) while the other code sends an immediate emergency alert (“Emergency Code”) within alarm system 100. The user would be required to enter each of the codes twice.

Step 220 executes by displaying the main dashboard screen. The processes available from this screen are disclosed in greater detail below. According to the disclosed embodiments, a sign up screen is provided. This screen may auto-populate as much information as possible from device 102. Some information, such as a phone number for device 102, may not be edited in this screen. A primary email account for the disclosed alarm system account may be populated from the mail application on device 102.

Other buttons on this sign up screen may include one to show the license agreement to the user. After the user agrees to the terms of the license agreement, web server 104 receives the entered information to create the account. The button also may allow the user to select a pay account and display a screen to complete the payment process. Other buttons may be available from the sign up screen, such as one to go to a screen to enter contacts, another to enter or create the codes, another to adjust settings, and one to retrieve information about alarm system 100. These buttons, however, may be disabled until the license agreement is accepted and the account created at web server 104.

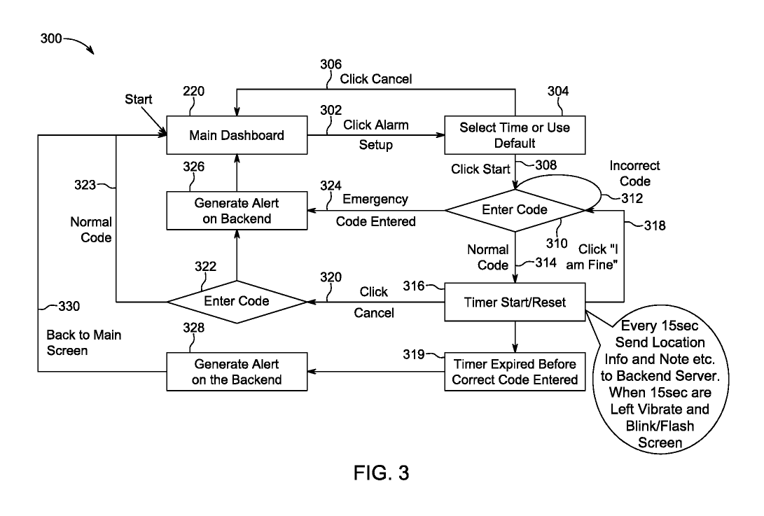

FIG. 3 depicts a flowchart 300 for performing alarm operations using device 102 within alarm system 100 according to the disclosed embodiments. Step 220 corresponds to step 220 in FIG. 2. Here, the user is at a main dashboard, or screen. Several operations may be selected from the main dashboard, such as going to a time alarm screen, entering contacts, setting up codes, viewing settings and the like. The user also may select to go to a family alarm screen or an emergency alarm screen.

Operation 302 is performed by the user by clicking an alarm setup, preferably from clicking the goes to time alarm screen button. A short-cut button may also be available on certain devices for quicker launch of the alarm. Step 304 executes by selecting a time for the timer, or using a default already set for the account. For example, the default timer may be 3 minutes, but the user wishes to make it 5 minutes. The timer is a background timer in that the user does not control it once it is set. The user may set this time or use the default. Operation 306 is performed by the user clicking cancel, which returns flowchart 300 to step 220.

From step 304, operation 308 may be performed by clicking start. Step 310 executes by entering a code from the codes created for the account by the user. Operation 312 is performed if the user enters the incorrect code to return flowchart 300 back to step 310 to re-enter the code. If step 310 is repeated a certain number of times, such as 5, then the account may shut down and an alert sent that someone is trying to enter into the application without approval.

Operation 314 is performed by entering the normal code. Thus, according to some embodiments, the user enters a safety, or normal, code at the appropriate alarm screen. Buttons on this screen only become active is the proper code is entered. The user may select or unselect email and SMS service for this alarm sequence. The user may click a button to toggle this service. The user may click an activate button to enable the alarm. The disclosed embodiments may only activate if a service is chosen. In other words, if no email or SMS service is chosen, then no alerts to the family or friends may be sent. The disclosed embodiments will inform family and friends from contact list. These processes may be performed on web server 104.

Step 316 executes by starting or resetting the timer. The user has to keep entering the safety, or normal, code to keep disabling the alarm so that an alert is not sent to the authorities or the contact list. The user may disable the alarm when she feels safe, as disclosed below. Further, this step may send location information and any other pertinent information every 15 seconds or other suitable interval to the backend server, such as web server 104. Further, when a short configurable interval like 15 seconds is left to enter the code, device 102 may vibrate or blink/flash its screen. An audible alarm or countdown noise may be implemented, but this may alert others of the user's location.

Operation 318 is performed by the user clicking that she is fine, or a continue button. Then, the timer starts again and returns to step 310 to have the user re-enter the code. Step 319 executes by having the timer expire before a correct code can be entered. If this occurs, then an emergency situation probably exists. Thus, step 328 is executed by generating an alert on the backend, for example, at web server 104. The alert may be sent to the authorities and the user's selected contact list depending on the user selection at the start of the alarm process.

Operation 320 is performed by the user clicking cancel during the timer countdown sequence. If so, then the user is asked to enter the code in step 322. Operation 323 is performed if the normal code is entered to return the user back to step 220, or the main screen. Otherwise, the improper code is entered and step 326 executes by generating an alert on the backend. Referring back to step 328, as well as step 326, operation 330 is performed by returning the application back to the main screen in step 220.

According to the disclosed embodiments, the user may be taken to an active alarm screen after entering the safety code. If the valid code is entered, then the buttons for “continue” and “stop” become active. The “continue” button, when pressed at the appropriate times, keeps the countdown sequence for another time period. The timer is reset to the configured or selected time, and a message is sent to the website, or web server 104, and the location of device 102.

If the user clicks the “stop” button, then she is prompted to re-enter the code to disable the alarm sequence or “no” to continue the alarm sequence. Information may be sent to the website, or web server 104, to record the event. If stopped, then the alarm sequence is cancelled.

Throughout these actions, if network 101 is not available or becomes unavailable, then the user is alerted through the application. A prompt may appear. The alarm sequence and timer operations may still continue in order to keep collecting information for when device 102 reconnects with network 101.

The countdown timer according to the disclosed embodiments may countdown according to the default time configured from the settings. Buttons may be provided on the screen to increase or decrease this time. The changes may occur in specific increments, such as 30 seconds. The disclosed embodiments may implement a minimum alarm countdown time, for example, of 1 minute. Thus, the user may enter a selected time period or adjust the default time period from the screen.

Device 102 may vibrate and the screen turns red when a short interval like 15 seconds is left in the timer period. At 0 seconds, or when the timer expires, another vibration is performed and the alert status sent to the website. Further, at any time during the alarm stage the user may record a short voice message to be submitted to the website. The user may click a record button once to record and a second time to stop. Alternatively, a video message may also be recorded to forward over network 101 with the alerts.

Referring back to step 310, an emergency code may be entered in operation 324. This operation move flowchart 300 straight to step 326 to generate an alert on the backend. Moreover, the disclosed application may be prompted to provide an emergency alarm screen. The emergency code is different from the safety, or normal, code used for the reverse alarm process disclosed above. When the emergency alarm screen is displayed, the user enters the code to activate the appropriate buttons. The user may select or unselect various services from the first responders, such as police, fire, ambulance, and the like. The user may then click an “activate” button to enable. The alarm is set up on the website, or web server 104.

Further, the emergency code is entered to imply that the user is in immediate danger. The alarm may become silent. The user also may record or upload an audio or video clip. Location and any other pertinent information of the user is provided to the web server at regular intervals.

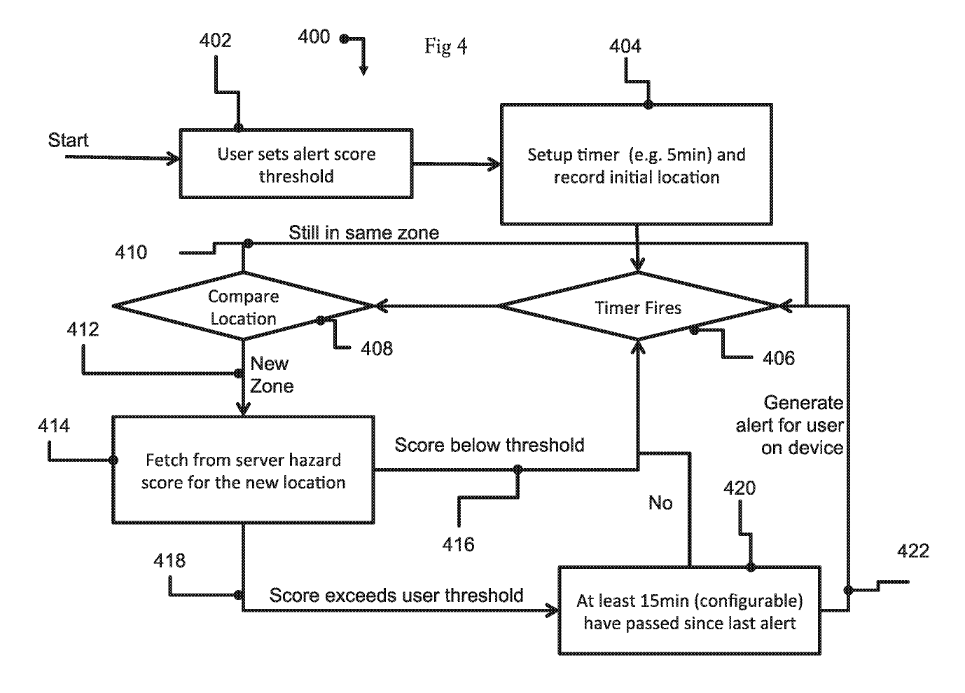

FIG. 4 depicts a flowchart 400 for performing a hazard score based alarm process according to the disclosed embodiments. Flowchart 400 may execute along with flowchart 300, or may be its own separate process. Step 402 executes by the user setting an alert score threshold. The user may set a value that, if exceeded, results in an alert to the user, or to the backend. The threshold may reflect the comfort level that the user has for a location. A low threshold means the user is not comfortable being in locations even remotely dangerous. A higher threshold may indicate that the user is confident to move through tougher areas.

Step 404 executes by setting up a timer and recording the initial location. The timer, for example, may be set for 5 minutes. Step 406 executes by firing the timer. At the end of the timer period, certain actions may be performed. Step 408 executes by comparing the location after the timer fires to the initial, or previous, location. Operation 410 is performed if the user is still in the same location.

Operation 412 is performed if the user is within a new zone, or location. Step 414 executes by fetching from web server 104 the hazard score for the new location. Operation 416 is performed if the fetched score is below the threshold set by the user, and flowchart 400 returns to step 406.

From step 414, operation 418 is performed if the fetched score exceeds the threshold. Step 420 executes by determining whether at least 15 minutes (or some other time period) have passed since the last alert. If no, then flowchart 400 returns to step 406 to fire the timer. If step 420 is yes, then operation 422 is performed to generate alert for the user on device 102. The alert may be a message or vibration alert on device 102.

The disclosed embodiments may determine the hazard scores for the different areas using the data collected as alarm sequences are enabled. The backend, or web server 104, keeps statistics of alerts across users of the application on devices 102.

In one embodiment, the data may be collected through crowd sourcing methods. For example, for a particular jogging route in the city of San Francisco, Calif., all the users using the alarm device may generate various forms or data that include safety and harmful conditions, hazards, alarm alerts, or any other condition that may be beneficial to another user. The system will collect data, both automatically and as entered by users, including how much time a user is taking to pass a certain path, and then provide that crowd sourced data to the user of the alarm system along with providing any suggestions of safety or route changes,

The disclosed embodiments may implement a hazard score algorithm that uses statistics of alerts grouped by location to generate a hazard heat map. The disclosed embodiments may generate an alert on device 102 alerting the user to be prepared or warn her that she is entering a potentially dangerous location given the current location of the user and the user's configured alert level. The disclosed embodiments also may track hazard trends over time in the locations for use by authorities or anyone else, possibly through device 110. The disclosed embodiments also may show crime statistics using the application for alerts sent during the alarm process.

The hazard score for a location may be determined by statistics group regions using census statistics for census groups (state, county, GEOID, LSAD, and the like), or by a radius based on GPS coordinates. The disclosed embodiments consider the timer activation rate, or the number of timers (T) activated per 1000 people (or any other number) based on population information. The disclosed embodiments also consider the alarm activation rate, or the number of alarms (A) per 1000 (or any other number) timers. Thus, the hazard score used for the embodiments disclosed by FIG. 4 may be a function of A and T, or the number of alarms per N timers and the number of timers activated per N people for a given location.

The disclosed embodiments also may send red alerts to nearby registered helpers within network 101. These helpers may be verified through a process and available within alarm system 100 to help people in need during an emergency situation. Examples of such helpers may be TSA pre-clearance personnel, registered taxi cabs or UBER drivers nearby, or other people interested in helping people near their location (such as a neighborhood watch) and have been pre-cleared by some registered authority.

The disclosed embodiments also may integrate with residential or commercial real estate monitoring services. Range extension is provided by activating the security system, such as in the lawn, when not in motion detector range of the embedded security system. Network 101 may provide an open application program interface to enable such cooperation.

Thus, device 102 and alarm system 100 may provide security tracking in anticipation of an event. The user enters the safety code to enable or disable tracking. Every N seconds, the code has to be entered to disallow alerting. The types of alarms may be configured by the user. An alarm may be issued to emergency services, such as 9-1-1, ambulances, local urgent care or emergency rooms, and the like. An alert also may be sent to family and friends set up by the user. The alert informs the family and friends about the time and location of the user.

Alerts may be sent as messages. Message types include emails, text messages, instant messages, calls (such as 9-1-1 or to contacts). Other messages types include audio or video clips to note any information provided by the user as well as stream information from the user to the appropriate authorities.

The disclosed embodiments may use device 102 to track the location of the user once alarm is activated and submitted on a continuous basis until the alarm is deactivated. This information may be collected to provide the hazard score for a location, as disclosed above.

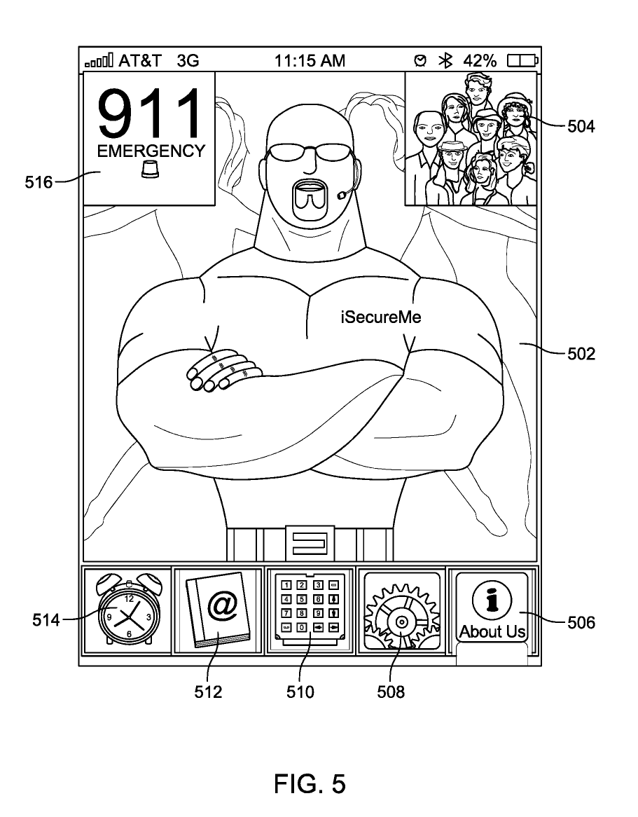

FIGS. 5-12 depict examples of screenshots used by the disclosed embodiments. The screenshots show an example interface for use with device 102. The screen shots are simple one implementation of the invention and provided for illustration. They are not used to describe every detail and feature of the invention. Several additional details that have not been described in the screen shots below are provided in other parts of this application.

The user enters information or the appropriate codes using the screens. Buttons are shown to accomplish the functions disclosed above. Using the features presented on the screens in FIGS. 5-12, a user may also set up or configure the account and develop customized screens menus or web pages.

FIG. 5 illustrates a screenshot on a display device that embodies the invention according to the disclosed embodiments. The main screen 502 is used to display all the activities and events that result from the user selections of various menu picks. For example the main screen 502 may show a log of events by time or show a map of where each event took place.

Selection 504 allows a user to navigate to the family alarm screen. One of the uses of this screen may be to alert just the user's family if an event is triggered. The user may define his/her family by adding them to their contacts list and identifying them as family or a friend.

Selections 506, 508, 510, 512 and 514 allow a user to navigate to associate screen for programming or editing preferences. Selecting About Us 506, the user can review information about the App or navigate to information about updates or information about the company and contact for assistance. The About Us 506 button may also describe each feature of the App is detail and provide suggestion on programming.

Selecting Settings 508 the user may be able to edit a variety of settings of the App, including, but not limited to brightness, alarm ring tone, various tunes, passwords, alert notifications etc.

Selecting Contacts 512 allows a user to review all their contacts and their detailed information. The selection also allows the user to add, deleted or edit contacts as well as generate groups. Selecting Alarm 514 takes the user to the Alarm screen that is discussed ahead. Further, selecting 911 Emergency Button 516 immediately initiates contact with 911 emergency services and provides the emergency services with data that may include, location of the user, details of the emergency, path the user had taken and had intended to complete, time of emergency, and other details that may help the emergency services in determining the nature of emergency and dispatching appropriate services.

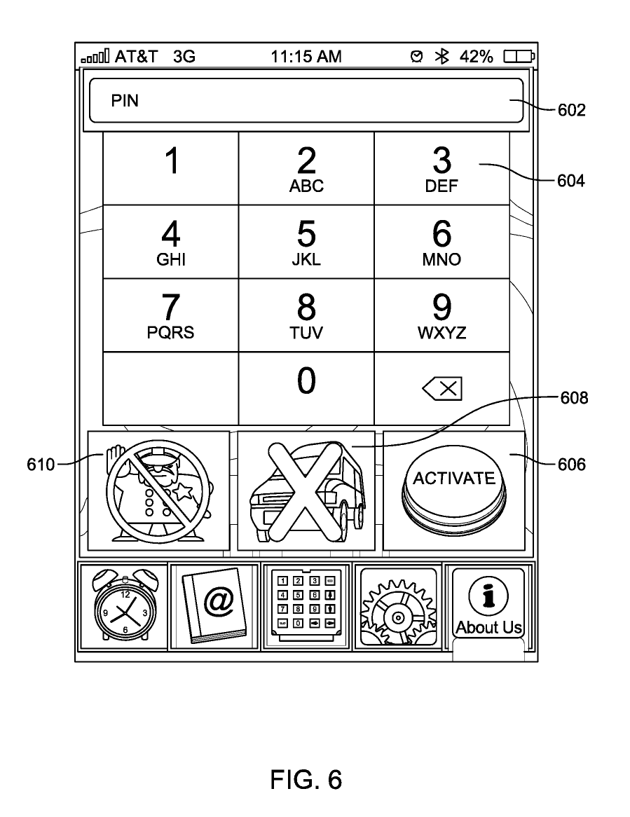

FIG. 6 illustrates an emergency alarm displayed on a device that embodies the invention according to the disclosed embodiments. Pin box 602 is used by the user for entering the pin or passcode to the Application. This code is also referred to as the safety code. A user enters their safety code when they feel they are now safe and secure in their environment. The buttons below become active only upon entering the correct safety code on the keypad 604.

Police selection button 610 allows a user to activate or deactivate the police service. Deactivating the police service button 610 means that the user is now safe and no longer feels a need for police to arrive at the scene. Deactivating the ambulance service button 608 means that the user is now safe and no longer feels a need for an ambulance to arrive at the scene. The user may make one or both selection or activate one and not the other. The Activate button 606 activates the alarm. The activate button may also alert the services as needed. In one embodiment, the user may only activate if a service is chosen. The alarm may also be setup on the service provider's website.

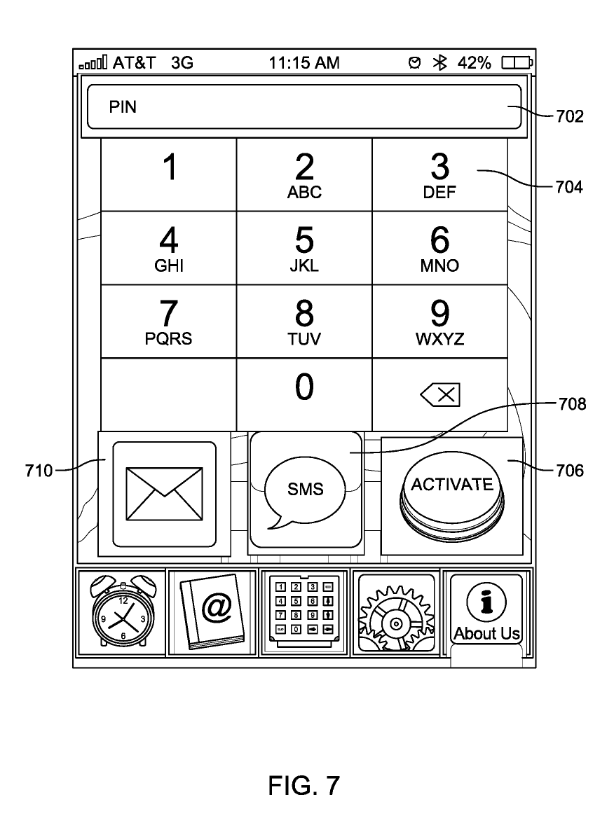

FIG. 7 illustrates a family and/or friend alarm displayed on a device that embodies the invention according to the disclosed embodiments.

User may select email button 710 or SMS or text button 708 and set these up in advance to alert their family, friends, and anyone else their email or text lists to alert them when an urgent situation arises or even to alert then that you are safe. This can also be used in the event of natural disasters, fires, or if you are travelling in a vehicle, aircraft, boat, train etc. For example, a user may have a separate group with several friends, relatives, co-workers, and other people involved in their life and they may alert all of them in real-time when they are either in a emergency situation or to identify that you are now safe and out of the emergency.

In another embodiment, the alarm can also be used to disclose that you have been in a car accident or have been entered into Emergency Room at a hospital or some other urgent situation, like a death in the family etc. Typically in urgent situation like when you are admitted to a hospital, there is little time to inform other or at times not possible to remember due to diminished mental capacity due to an accident, in such situations the user can preset the groups and simple press activate button. The alert will go out to everyone on their list and include all the details, such as location, time of occurrence, name of hospital and other identifying details that are prior to this invention historically were shared through manual processes many hours later by hospital staff once they can figure out whom to contact creating issues that may have been resolved if the family was alerted in real-time with this invention.

The Activate Button 706 enables the alarm. In one embodiment, the Activate Button 706 can only be selected upon prior selection of notification by either email or text or both. Button 702 allows a user to enter the pin by the keypad 704.

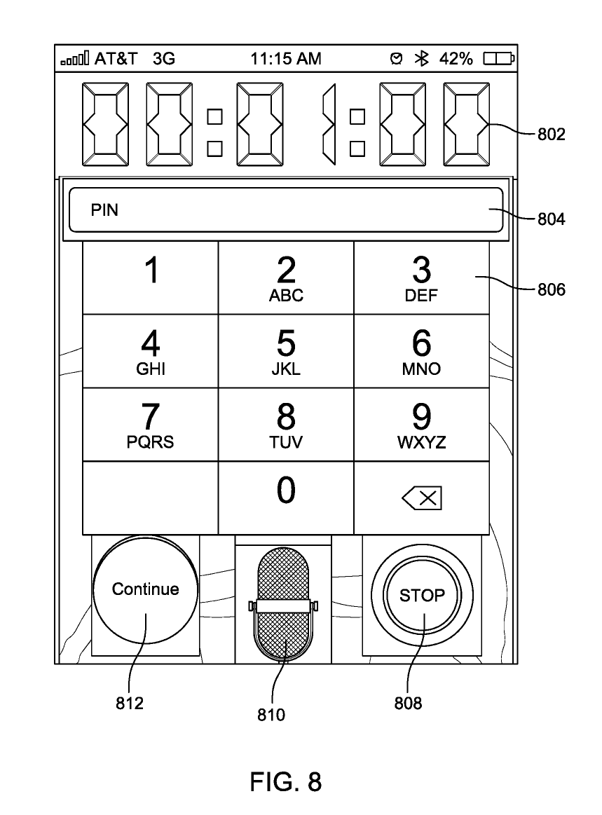

FIG. 8 illustrates an active alarm screen displayed on a device that embodies the invention according to the disclosed embodiments. The timer 802 is a countdown timer that continues with the default time configured from settings. The user may set the default to any number, such as 10 seconds, 1 min etc and the default timer starts at the set number, e.g. 1 min and then counts backwards till it reaches 0 seconds.

User enters correct pin/password in the pin box 804 to stop the counting down of the timer. If the correct pin is not entered, the countdown continues.

The user may also select a prompt that alerts the user prior to the sending of emergency signal. For example, at user may chose to have 15 seconds as a prompt in which case the screen turns red and vibrates when 15 seconds are left and at 0 seconds another vibration occurs and sends the alarm to a website or directly to authorities or friends and family.

The Auto-recording button 810 allows the user to record a short voice note that is transmitted along with the message to emergency services or friends and family. The user may describe the person who has been following them or any other detail about the environment, the suspicions car parked, or the details of the medical condition in the case of a medical emergency.

Continue button 812 and Stop button 808 allows a user to stop and continue the timer after they have entered the correct pin using the keypad 806.

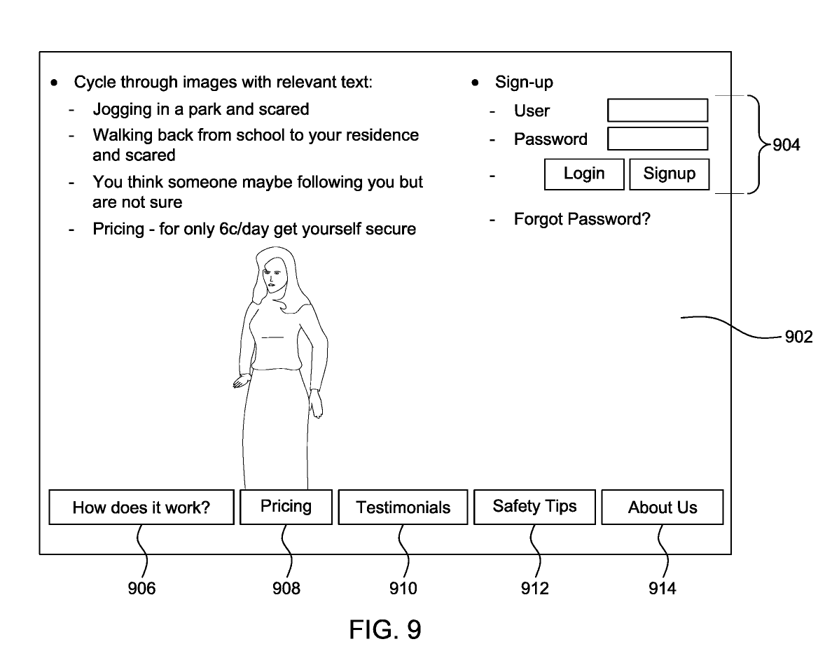

FIG. 9 illustrates an advertisement displayed on a device that embodies the invention according to the disclosed embodiments. When the alarm is not active, there may be options for user to allow advertising on their App. Advertisers may use login area 904 to enter and user Id and password and setup their profiles as well as advertising details. User may navigate through buttons 906, 908, 910, 912, and 914 to select any advertised product in the main screen 902 and find out more details about the advertised product, such as pricing 908 or how it works 906. The advertisements may also be about a certain jogging path and safety tips related to the path. Alternatively, the user may chose a premium version of the product or a paid version and opt out of advertising.

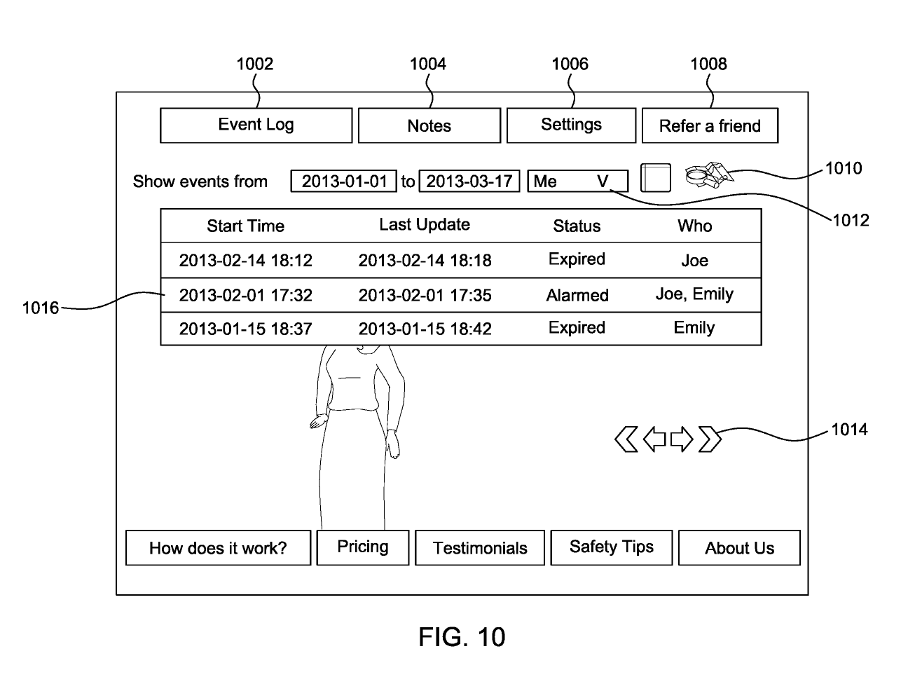

FIG. 10 illustrates an events list displayed on a device that embodies the invention according to the disclosed embodiments. Event log button 1002 displays a log of all the events, such as jogging path taken during a selected period of time 1012. Notes 1004 relate to further detail about the event that you may have written down or recorded, such as watch out for dark corner or steep path or certain dangers etc. Settings 1006 allows the user to set the manner in which they want the events displayed.

Map/List button 1010 allows a user to select between a map display of list display of the events. The map option will display all the events occurred during the specified time on a map by location.

User Self/Other button 1012 allows a user to view events that are either their own or event of another individual that has authorized you to review their event.

In another embodiment of this invention, the other selection 1012 allows you to track another individual, such as a friend or child, that has authorized and provide you secured access to track them in real-time. As such in the event of an emergency in which the other person has not enabled their Alarm, the user may still be able to track path and have the audio, video, display ON/Off to review further details and location of the emergency. The user may also refer a friend 1008 to add for tracking.

At selection 1016, the user may select a particular event from the log and the selection would bring up all the details relevant to that event. Toggle button 1014 allows a user to navigate between pages and events.

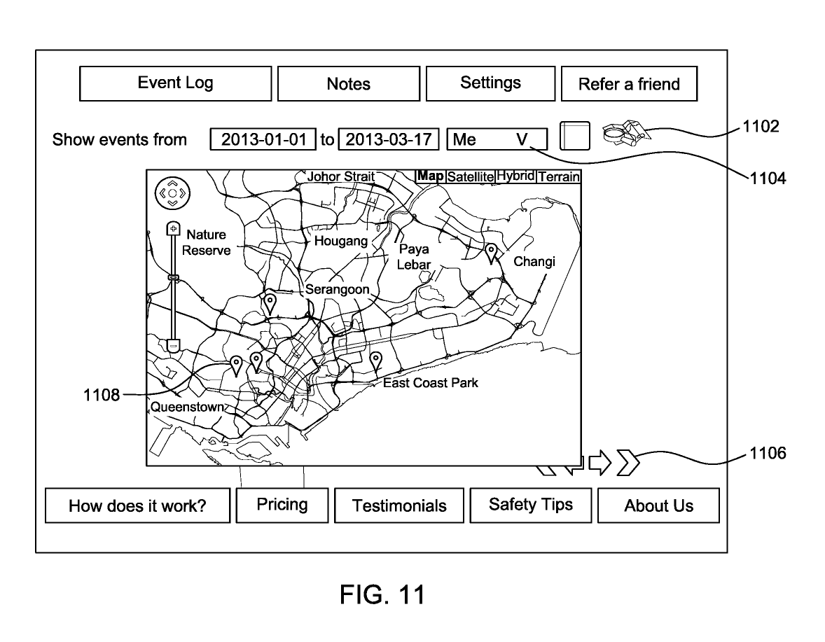

FIG. 11 illustrates an event map displayed on a device that embodies the invention according to the disclosed embodiments. Map points 1108 indicate the location of a user or someone they are tracking. 1102 is selection between map and list view. 1104 allows selection between users, self or others. 1106 is the toggle switch to switch between screens and pages. FIG. 11 may appear once you have selected the event log to show all the events by their location as map points. User may also select a particular map point which will take them to the event detail associated by that map point, e.g., their jog in Queenstown or another jog they did on a different day in East Coast Park.

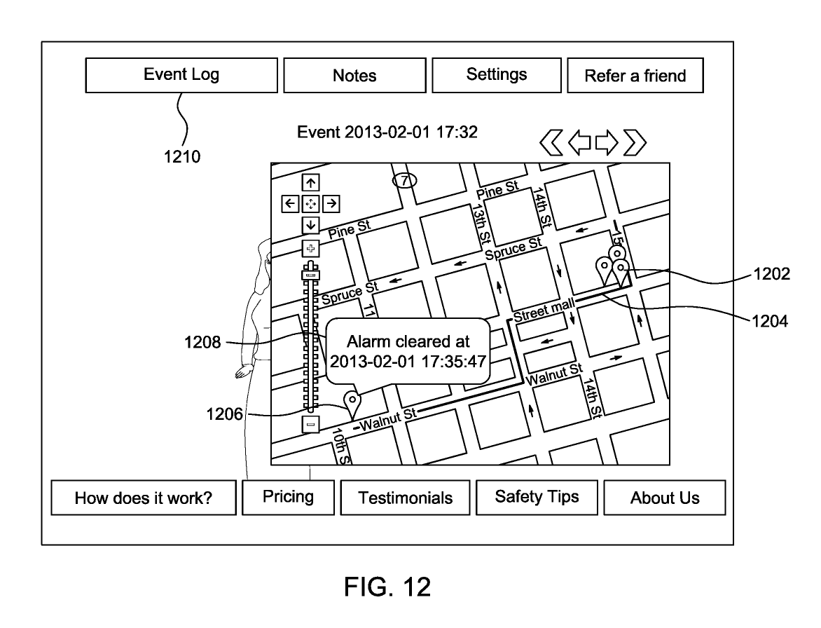

FIG. 12 illustrates a path taken by a user on a map which is displayed on a device that embodies the invention according to the disclosed embodiments. Map point 1202 shows the location of start and Map point 1206 shows the location at which an alarm activity happened. The map points will also show the time stamp at which the user passed those map points along their path 1204. Selection of a map point also provides details of the alarm such as when the alarm activity happened, when alarm was enabled, or when alarm was cleared 1208.

It will be apparent to those skilled in the art that various modifications and variations can be made in the disclosed embodiments of the disclosed device and associated methods without departing from the spirit or scope of the invention. Thus, it is intended that the present invention covers the modifications and variations of the embodiments disclosed above provided that the modifications and variations come within the scope of any claims and their equivalents.

What is claimed is:

1. A method for using an alarm device over a network, the method comprising:
activating a timer in response to input received on the alarm device;
counting down the timer for a period of time;
prior to an end of the period of time, entering a code into the alarm device;
sending an alert update over the network to a server, wherein the alert includes information about the alarm device during the period of time; and
generating an alert message if the code is not entered prior to the end of the period of time.

2. The method of claim 1, further comprising entering an emergency code into the alarm device.

3. The method of claim 2, further comprising reporting an emergency situation over the network in response to the emergency code.

4. The method of claim 1, wherein the sending step includes sending location information with the alert update.

5. The method of claim 1, further comprising disabling the timer upon entering the code into the alarm device.

6. The method of claim 5, further comprising collecting the information for each alert update.

7. The method of claim 1, further comprising a mobile phone for displaying the timer for count down and sending alerts to a network.

8. The method of claim 7, further comprising obtaining crowd sourced data obtained by a plurality of users of the alarm device and presenting the crowd sourced data to the user.

9. The method of claim 8, further comprising a suggestion engine that provides routing suggestions to the user of the alarm system based on data obtained through crowd sourcing, wherein the suggestion may be to use or avoid a particular route based on safety conditions.

10. The method of claim 1, wherein the alarm device is used during an event that includes, fire emergency, medical emergency, natural disasters, personal safety event, and travelling on a land, sea, or air vehicle.

11. A method for warning a user about a potential hazard for a location, the method comprising:
setting a threshold for a hazard score;
activating a background timer for a period of time at first location;
determining a second location at the end of the period of time;
obtaining a new location hazard score of the second location if the second location differs from the first location; and
warning the user of the new location hazard score exceeds the threshold.

12. The method of claim 11, further comprising a mobile phone for displaying the hazard score, background timer, and related steps for warning the users of a potential hazard.

13. The method of claim 12, further comprising obtaining crowd sourced data obtained by a plurality of users of the alarm device, wherein the crowd sourced data includes hazard scores, and presenting the crowd sourced data to the user.

14. The method of claim 13, further comprising a suggestion engine that provides routing suggestions to the user of the alarm system based on hazard scores obtained through crowd sourcing, wherein the suggestion may be to use or avoid a particular route based on safety conditions.

15. The method of claim 13, wherein the hazard score may be determined based on the number of occurrences an alarm is activated, wherein a high occurrence resulting in a high hazard score denoting the possibility of an emergency situation.

16. An alarm system comprising:
an alarm device connected to a network, wherein the alarm device is configured to receive at least one code;
a timer within the alarm device to count down a period of time when activated; and
a web server to receive information from the alarm device,
wherein the alarm device is configured to send an alert update to the web server if a safety code of the at least one code is entered during the period of time,
wherein the alarm device is configured to send an emergency alert if the safety code is not entered during the period of time or if an emergency code is entered.

17. The alarm system of claim 16, wherein the sending an alert update step includes sending location information with the alert update.

18. The alarm system of claim 16, wherein alarm device is disabled when the code received corresponds to a preset code set by the user to identify that the user is safe.

19. The method of claim 16, further comprising obtaining crowd sourced data obtained by a plurality of users of the alarm device and presenting the crowd sourced data to the user.

20. The method of claim 19, further comprising a suggestion engine that provides routing suggestions to the user of the alarm system based on data obtained through crowd sourcing, wherein the suggestion may be to use or avoid a particular route based on safety conditions.
